(19) United States
(12) Patent Application Publication
(10) Pub. No.: US 2007/0042234 A1
(43) Pub. Date: Feb. 22, 2007

(54) Liquid fuel type fuel cell and fuel therefor

(75) Inventors: Ryoichi Okuyama, Osaka (JP); Masashi Motoi, Osaka (JP); Yukio Fujita, Osaka (JP); Eiichi Nomura, Osaka (JP)

Correspondence Address: THE WEBB LAW FIRM, P.C., 700 KOPPERS BUILDING, 436 SEVENTH AVENUE, PITTSBURGH, PA, 15219, US

(73) Assignee: GS YUASA CORPORATION, Kyoto (JP)

(21) Appl. No.: 10/556,253

(22) PCT Filed: Mar. 29, 2004
(86) PCT No.: PCT/JP04/04464

§ 371 Date: Nov. 10, 2005

(30) Foreign Application Priority Data
May 16, 2003 (JP) 2003-139133
May 16, 2003 (JP) 2003-139135

(51) Int. Cl. H01M 8/00; H01M 8/10; C10L 1/32; C10L 1/10

(52) U.S. Cl. 429/12; 429/30; 44/282; 44/300

(57) ABSTRACT

A dye is added into a methanol/water fuel of a direct methanol fuel cell, and the dye is adsorbed and removed by a filter cartridge provided in the upstream of a cell stack. Carbon black, etc. may be added instead of the dye. Alternatively, a scenting agent such as formic acid and methyl formate, or an antiseptic may be added.

### FIELD OF THE INVENTION

The present invention relates to a liquid fuel type fuel cell whose fuel, such as methanol, ethanol, isopropanol, butanol, and dimethylether, is mixed with water and supplied to its fuel electrode directly and a fuel used for the same. The present invention relates especially to prevention of the user from drinking it by mistake and prevention of putrefaction of it.

### BACKGROUND OF THE INVENTION

In the direct methanol fuel cell, a methanol/water composite fuel of about 1-10 wt % is used and directly supplied to a fuel cell without reforming methanol into hydrogen. Since the direct methanol fuel cell does not require a reformer, it has a simple structure and is lightweight. Especially small-sized direct methanol fuel cell is promising for power supply of portable electronic devices such as a portable telephone, a video camera, and a notebook-type personal computer. Japanese Patent Application Laid-open No. 2001-313046 (hereinafter, referred to as Patent Document 1) proposes a structure where a fuel is supplied to a fuel tank from a cartridge.

If the user drinks a fuel of methanol by mistake, it will be harmful. It does also harm to the skin. Methanol is colorless and transparent, and a water solution of a concentration of about 3 wt % has a weak smell. Consequently, the users of the fuel cell such as general consumers are likely to treat it carelessly in the similar manner as mere water. Other fuels, such as isopropanol/water, butanol/water, and dimethylether/water, are also harmful to the human body, if the user drinks it by mistake.

The inventors found out phenomena that when a portable direct methanol fuel cell that started to be used once was left unused at room temperature for about one month, the fuel gave out a foul smell and the fuel originally colorless and transparent as well as waste fuel changed their colors, etc. In case of observing the color-changed fuel, we detected microorganisms such as mold and putrefactive bacteria, and its foul smell was a sour smell close to a formic acid smell.

This indicates that microorganisms in the atmosphere entered the fuel cell from an air intake of the fuel cell and bred by utilizing methanol in the fuel and aldehyde, carboxylic acid and the like that were by-products of an electrode reaction and included in the waste fuel. Since the consuming public may touch the downsized direct methanol fuel cell used for portable electronic devices or the like with their hands, generation of microorganisms is not desirable. Moreover, a change in color and a foul smell of the fuel, especially the foul smell, could cause the fuel cell to loose its reliability to the consumers. Furthermore, if microorganisms sticks to the air electrode and the fuel electrode, it is possible that they impede diffusion of the fuel and air in the electrodes or poison the electrode catalyst. The inventors have checked experimentally that the output of the direct methanol fuel cell declines because of putrefaction of the fuel, etc. Here, we consider putrefaction in the direct methanol fuel cell as a problem. If the fuel is changed to isopropanol/water, etc., complete oxidization of the fuel to CO₂ and water becomes more difficult, and consequently nutrient for microorganisms will increase and putrefaction will become a more serious problem. As far as the inventors surveyed, breeding of microorganisms in the direct methanol fuel cell is a new problem that has so far not been examined until now.

### SUMMARY OF THE INVENTION

An object of the present invention is to prevent a user from drinking a fuel of a liquid fuel type fuel cell by mistake, and to prevent the fuel from putrefying.

Another object of the present invention is to prevent cell characteristics from being adversely affected due to the coloring or scenting of a fuel.

Still another object of the present invention is to make it easy to simply remove additives and impurities in the fuel and in the waste fuel, so as to add an additive to the fuel and to remove impurities from waste fuel.

Yet another object of the present invention is to easily obtain an antiseptic effect for the whole liquid fuel type fuel cell.

A further object of the present invention is to prevent performance degradation of the fuel electrode and the air electrode, which is caused by an antiseptic.

The liquid fuel type fuel cell of the present invention has the air electrode and the fuel electrode provided on both sides of a proton conductive membrane to construct the MEA (membrane-electrode-assembly), and generates electric power by supplying a water liquid fuel to the fuel electrode of the MEA and supplying air to the air electrode thereof, wherein the fuel is colored or scented so that the user may not drink it by mistake, and an antiseptic agent is added into the fuel so that putrefaction of the fuel is prevented. The liquid fuel type fuel cell of the present invention is characterized by preventing putrefaction of the fuel by addition of an antiseptic in the cell. Moreover, the fuel for the liquid fuel type fuel cell of the present invention is characterized in that the fuel is a water liquid fuel for a liquid fuel type fuel cell using a proton conductive membrane, wherein the fuel is colored or scented, or an antiseptic is added to the fuel.

In the present invention, since the fuel of a liquid fuel type fuel cell is colored or scented, or an antiseptic is added to the fuel, coloring or scenting the fuel can prevent the user from drinking it by mistake or prevent the user from accidentally putting it on the skin, and further generation of mold, putrefactive bacteria, etc. can be prevented by the antiseptic.

Preferably, the fuel is colored black by dispersing carbon fine powder in the fuel. Carbon is a material used for the fuel cell as active carbon of the electrodes, carbon sheet outside the electrodes, etc., and is stable as itself, and consequently carbon is not likely to degrade cell performance by poisoning the electrodes.

Alternatively, preferably, the fuel is colored by adding a coloring agent in the fuel. Such a coloring agent as can color the fuel by a small amount is preferable. Especially preferably, a filter for removing a dye is provided in the upstream of the MEA in order to prevent contamination of the MEA by the dye. As a material of the filter, for example, active carbon is preferable. However, a filter has its life, the filter is used, for example, as a detachable filter cartridge to the fuel system.

In case of scenting the fuel, preferably a carboxylic acid with a carbon number of 1-4, or an ester of a carboxylic acid with a carbon number of 1-4 and an alcohol with a carbon number of 1-4, or an ether of two alkyl groups each with a carbon number of 1-4 is added into the fuel to scent it.

These scenting agents are cell reactants or ester of carboxylic acid of the cell reactant and alcohol of the fuel. For example, in case of a methanol/water fuel, they are formic acid and methyl formate, etc. In case of a butanol/water fuel, they are, for example, butanoic acid or ester of butanoic acid and butyl alcohol. Moreover, the liquid fuel type fuel cell can operate with ether fuels such as dimethylether. Ester in the form of R—O—R′ (both R and R′ being alkyl groups with a carbon number of 1-4) is a compound usable as a fuel or an analogous compound to a compound used as a fuel.

The most preferable scenting agent among them is formic acid and methyl formate. They decompose easily by an electrode reaction and do not poison the electrodes.

A liquid fuel type fuel cell of the present invention is a cell that has an air electrode and a fuel electrode provided on the both sides of a proton conductive membrane to comprise an MEA, and generates electric power by supplying a water liquid fuel to the fuel electrode of the MEA and supplying air to the air electrode, further comprising: a filter for removing additives or impurities in the fuel or in the waste fuel.

Preferably, the filter is a detachable filter cartridge.

By this arrangement, it becomes possible that various impurities are added to the fuel without contaminating the MEA, and it becomes also possible that impurities are removed from the waste fuel so that discarding of the waste fuel is made easy or fuel components such as methanol is added to the waste fuel so that the waste fuel is used cyclically.

An antiseptic is added, for example, into the fuel, or added to any of the following locations: side walls of the fuel tank or waste fuel tank; appropriate locations inside these tanks; side walls of a spacer surrounding the MEA (a composite of the proton conductive membrane and electrodes); carbon sheet near the MEA; and the like. Among these locations, a method of adding an antiseptic into the fuel is convenient, because all locations from the fuel tank to the waste fuel tank can be treated with the antiseptic, and each time the fuel is added, the antiseptic is also added. The amount of addition of the antiseptic is specified to a concentration of 10 wtppm-1 wt % relative to the fuel, preferably 100 wtppm-1 wt %.

An antiseptic that does not poison electrode catalyst of the fuel electrode and the air electrode is desirable. Although glycerin, etc. is not excluded in particular, glycerin, etc. is likely to be decomposed by the electrode incompletely and its reactant may poison the electrode catalyst, and consequently it is not desirable. On the other hand, organic aromaticity antiseptic including oxygen atoms, especially such organic aromaticity antiseptics including oxygen atoms whose aromatic ring is not a hetero ring but a carbon ring, most preferably a benzene ring are hard to be decomposed by the electrode catalyst, and adsorption to the electrode catalyst and resolve to the fuel are reversible, and consequently that agent is very unlikely to poison the electrode catalyst. Therefore, they are desirable. Such antiseptics include, for example, para-oxybenzoic acid (HO-φ-COOH), its derivatives, para-dihydroxybenzene (HO-φ-OH), its derivatives, phenol, its derivatives, etc. The symbol φ denotes a benzene ring, positions of an activated group is represented by para, meta, and ortho. Here, para-oxybenzoic acid and para-dihydroxybenzene were shown. Positions of the two activated groups may be ortho or meta. Kinds of aromatic series are not limited to benzenoid, but may include biphenyl, naphthalene, azulene, anthracene, phenanthrene, etc. Among them, oxybenzoic acid, dihydroxybenzene, phenol, and their derivatives are being used for cosmetics, food, etc. and it is safe for the user to contact the skin with them in discarding the waste fuel.

It is known that silver compounds such as AgCl, copper compounds such as Cu₂O, and compounds of Sn or Zn, etc. have an antiseptic effect. If any of these inorganic compound that is water soluble is solved in the fuel, there is the possibility that it is reduced by, for example, the fuel electrode and forms an alloy with the electrode catalyst. On the other hand, when inorganic antiseptics, water insoluble such as AgCl and Cu₂O are added into the fuel by being supported on a support, it results in only increase of active carbon that is the electrode material and there is no fear of poisoning, even if it adheres to the fuel electrode and the air electrode. Silica gel (preferably containing an alkali metal of 100 wtppm or less), etc. may be used for a support. Although it does not intend to limit the antiseptic in particular, antiseptics containing alkali metals and alkaline earth metals of, for example, 300 wtppm or more are not preferable. These substances may change the electric conductivity of the proton conductive membrane.

If an organic aromaticity antiseptic including oxygen atoms or an insoluble inorganic antiseptic supported on a support is used, there is little fear that the electrode catalyst suffers poisoning or the electric conductivity of the proton conductive membrane is made to change, and it is safe even if the user contacts the skin with the waste fuel in discarding it. Incidentally, since the fuel used for the fuel cell is mainly water at a concentration of, for example, 90 wt % or more, the inorganic antiseptic only needs to be insoluble in water.

As a fuel, methanol/water is desirable, however, eternal/water, isopropanol/water, butanol/water, dimethylether/water, etc. may be used. Its concentration may be set appropriately according to the well-known technology. Moreover, materials and structures of cell structure members such as a proton conductive membrane, an air electrode, and a fuel electrode are well known, and they are allowed to be defined appropriately.

### BRIEF DESCRIPTION OF THE DRAWINGS

FIG. 1 is a block diagram of a direct methanol fuel cell of an embodiment where a coloring agent or scenting agent is added to a fuel;

FIG. 2 is a principal part sectional view of a filter cartridge used in the above-mentioned embodiment;

FIG. 3 is a perspective view of a direct methanol fuel cell according to a different embodiment;

FIG. 4 is a principal part enlarged sectional view of a unit cell of FIG. 3;

FIG. 5 is a perspective view of a direct methanol fuel cell of an embodiment in which an antiseptic is added to the fuel;

FIG. 6 is a principal part sectional view of a unit cell of the direct methanol fuel cell of the above-mentioned embodiment;

FIG. 7 is a block diagram of a direct methanol fuel cell that is a modification from the above.

FIG. 8 is a view showing initial characteristics of the direct methanol fuel cell of the above-mentioned embodiment; and

FIG. 9 is a view showing characteristics after leaving the direct methanol fuel cell of the above-mentioned embodiment unused at room temperature for one month.

### DESCRIPTION OF THE PREFERRED EMBODIMENTS

### First Embodiment

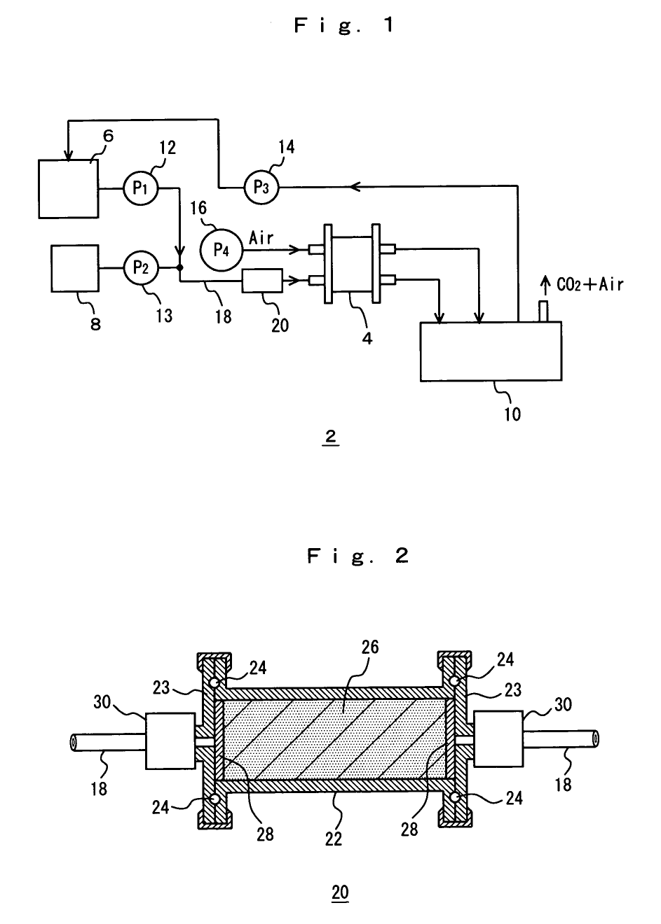

FIGS. 1 to 4 show an embodiment where a measure of coloring or scenting is taken and its modification. FIGS. 1 and 2 show an embodiment of a direct methanol fuel cell 2 of a stationary set (Embodiment 1). In these figures, the numeral 4 denotes a cell stack, 6 denotes a fuel tank, 8 denotes a high concentration methanol tank, and 10 denotes a waste liquid tank. The cell stack 4 used is one that MEA's each of which has a fuel electrode and an air electrode provided on both sides of a proton conductive membrane, made up of a solid polymer, and is coated with, for example, gas-permeable carbon sheet are sandwiched between separators. The separator is made up of, for example, a carbon plate or stainless plate, on which a groove for supplying fuel and a groove for supplying air are provided to supply a fuel and air. The fuel tank 6 accommodates methanol aqueous solution of about 1-10 wt %, in the example, 3 wt %. The high concentration methanol tank 8 reserves high concentration methanol aqueous solution of 10-60 wt % in order to make up for a decrease in methanol concentration in the fuel. The waste liquid tank 10 contains waste fuel that passed through the cell stack 4. The numerals 12-14 denote liquid sending pumps, which are controlled by monitoring the methanol concentration in the fuel. The liquid sending pump 12 supplies a methanol aqueous solution of a predetermined concentration from the fuel tank 6, the liquid sending pump 13 replenishes methanol from the high concentration methanol tank 8, and the liquid sending pump 14 is used to make the waste fuel in the waste liquid tank 10 re-circulate. The numeral 16 is an air pump for supplying air to the air electrode side of the cell stack 4. A filter cartridge 20 is attached detachably in a fuel supply line 18 running from the liquid sending pumps 12, 13 to the cell stack 4.

FIG. 2 shows a structure of the filter cartridge 20, wherein the numeral 22 denotes pipe, 23 denotes a pair of lids located upstream and downstream, 24 denotes O-ring for preventing fuel leakage, and active carbon 26 is accommodated in the pipe 22. The numerals 28, 28 denote glass filters, which can be changed to have appropriate filter material, and prevents the active carbon from running over into the fuel supply line 18. The numeral 30 is a joint that attaches the filter cartridge 20 detachably to piping of the fuel supply line 18.

Active carbon 26 removes a dye used for coloring the fuel. The form of active carbon may be a granulated shape, a sheet type, etc. Instead of active carbon, a hollow fiber, a silica gel filter, etc. may be used. In case of using silica gel, one that has an alkali metal content of 100 wtppm or less is preferable. It is preferable that the filter cartridge 20 is attached, for example, to a fuel supply port leading to the cell stack 4 or between piping of the fuel supply line 18 as shown in FIG. 1. In addition to these locations, it may be provided in the fuel tank 6 or in the high concentration methanol tank 8. Moreover, in the case where installation of the filter cartridge 20 is for some purpose other than removal of the dye, it may be provided in the waste liquid tank 10. Installation done in this way makes it easy to remove a dye in the fuel tank 6 or in the high concentration methanol tank 8, or to remove impurities from the waste liquid of the waste liquid tank 10 and reuse the waste fuel. Moreover, since the life of the filter cartridge 20 is limited, it is preferable that, in case of attaching it in the fuel supply line 18, etc., the filter cartridge 20 is made detachable through the joint 30, etc. and that in case of installing it in the tanks 6-10, it is made capable of being put in and put out through a lid of the tank, etc.

A problem in the direct methanol fuel cell 2 is that the methanol/water mixed solution of the fuel is harmful. In connection with this, in the example, the methanol/water fuel is, for example, colored. What is necessary for coloring is just to use a proper coloring agent, etc., and preferably, a dye is used. The dye may be acid dyes, basic dyes, or other dyes. The acid dyes such as an azo dye are more preferable than the basic dyes, etc., because of high water solubility. Then, addition of a dye by, for example, 0.1-100 wtppm, preferably 0.5-20 wtppm, into the fuel will result in coloring of the fuel.

In case of an acid dye, the dye will dissociate into an alkali metal ion, an ammonium ion, and an anion in the fuel. Then the alkali metal ion is likely to change characteristics by performing ion exchange with proton in the proton conductive membrane. Moreover, anion of a dye adheres to the fuel electrode catalyst, etc., which is likely to change catalytic activity. Although the basic dyes do not contain alkali metal ions, they are the same as acid dyes in that they are likely to adhere to the fuel catalyst to change its characteristics. Because of this, the dye is removed by adsorbing it with the active carbon 26 in the filter cartridge 20. Since adsorbing power of active carbon will be saturated if a large quantify of dye is adsorbed, the filter cartridge 20 is made exchangeable. In case of a hollow fiber, since it allows water and methanol to permeate through but does not allow a dye molecule having a large molecular weight to permeate through, it can remove the dye similarly. Silica gel also adsorbs and removes polarity dye molecules.

What is necessary for coloring the fuel is just to add a proper coloring agent or pigment. It is desirable to add, for example, carbon fine powder as a pigment. Carbon material such as active carbon and carbon black is the principal component of the electrode catalyst of the MEA, and a large quantity of carbon is used for the carbon sheet used as a gas diffusion layer and the like. For this reason, even if carbon fine powder adheres to the electrodes, the carbon sheet, etc., the influence on cell characteristics is small. Carbon fine powders include carbon blacks such as acetylene black, ketjenblack, and oil-furnace carbon black, graphite fine powder, and fullerene, etc. Among them, carbon blacks are preferable, because impalpable powder is readily obtained, capable of coloring the fuel by a small amount of addition, and hard to subside. It is preferable that the mean particle size of carbon fine powder is 0.01-100 μm in terms of secondary grain size, more preferably 0.3-30 μm, and most preferably 1-10 μm. Hydrophilicity of carbon fine powder can be adjusted properly by a kind, manufacture conditions, etc. of fine powder. If necessary, the hydrophilicity may be increased by treating it with a small amount of a surfactant. Moreover, it is preferable that the carbon fine powder disperses uniformly in the fuel or a part of the carbon fine powders disperses and a part thereof is afloat on the surface of the fuel. The amount of addition of carbon fine powder is specified to, for example, 0.03-10 wt % relative to the fuel, preferably 0.03-3 wt %, and more preferably 0.1-1 wt %.

What is necessary for scenting the fuel is just to add an appropriate smell component. Such a smell component as is contained in the fuel originally or is a component generated from the fuel by an electrode reaction is preferable because it does not degrade the cell characteristics. As such a component, for example, carboxylic acid with a carbon number of 1-4, especially formic acid that is easily decomposed on the electrode, are preferable. Moreover, ester of carboxylic acid with a carbon number of 1-4 and alcohol with a carbon number of 1-4 is ester composed of carboxylic acid that are generated by partial oxidation of the fuel and alcohol of the fuel, which is not likely to degrade the cell characteristics. Generally such ester has a strong smell. In addition, ether with a carbon number of 1-4 such as dimethylether and diethylether is a substance that can be used as a fuel for the liquid fuel type fuel cell as itself. Then, if such ether is added to a methanol/water fuel, it can warn the user not to drink the fuel by its ether smell. The concentration of the scenting agent is preferably 1-20 wt %. However, more preferably the concentration is specified to 3-10 wt %.

In the case where coloring is done with active carbon and in the case where a scenting agent is added, the filter cartridge 20 is originally unnecessary. However, even in such a case, the filter cartridge 20 may be provided in the upstream of the cell stack 4 and remove these agents. Again, a coloring agent and a scenting agent are for warning the user not to drink the fuel or not to contact the skin with the fuel in handling the fuel. Therefore, a coloring agent and a scenting agent are components that do not need to be included in the fuel after the fuel was filled in the fuel tank 6 or the high concentration methanol tank 8.

### Second Embodiment

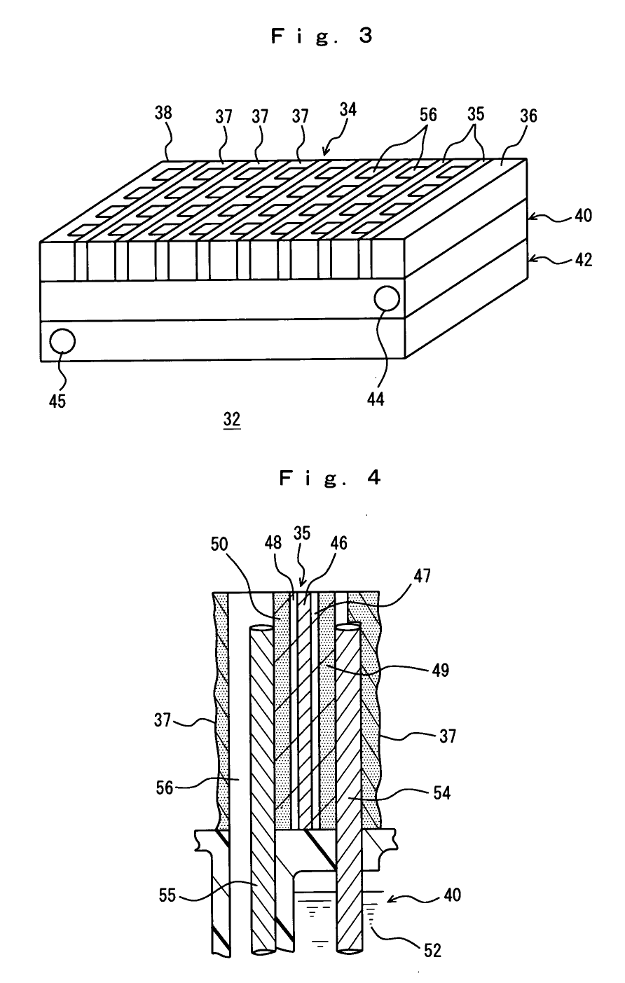

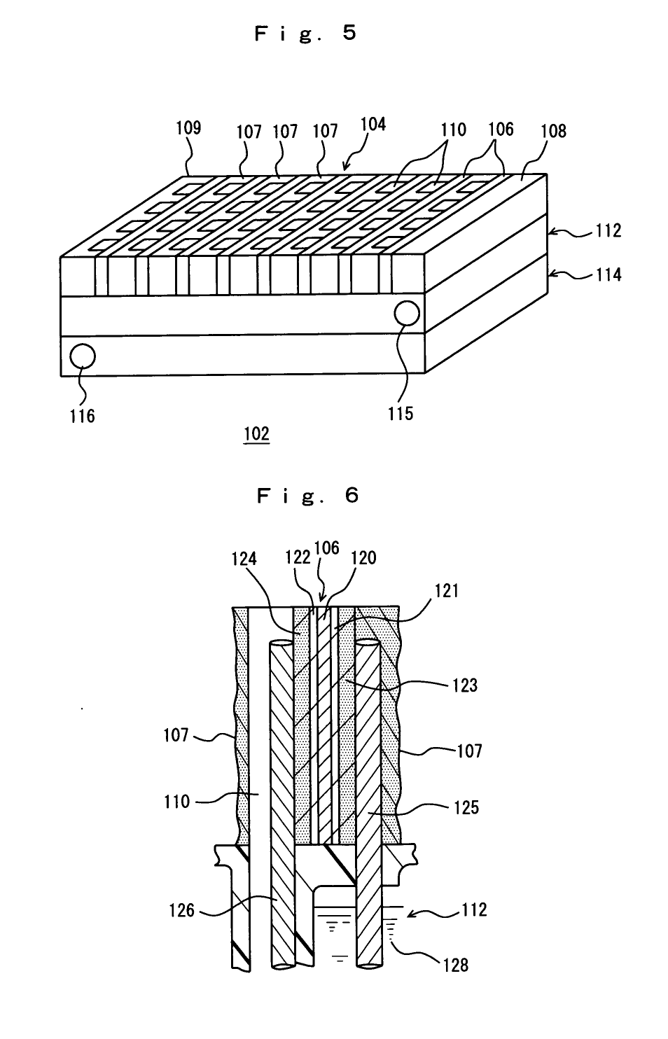

FIGS. 3 and 4 show a small-sized direct methanol fuel cell 32 used for a portable electronic device, etc. The numeral 34 denotes a cell stack, which is a serial connection of a plurality of MEA's 35, 36 to 38 denote separators, 40 denotes a fuel tank, and 42 denotes a waste fuel tank, and 56 denotes an air supply hole. Moreover, a valve 44 is for supplying the colored or scented fuel from an unillustrated cartridge to the fuel tank 40. A valve 45 is for discharging the waste fuel from the waste liquid tank 42.

FIG. 4 shows a structure of a unit cell, wherein the numeral 46 denotes a proton conductive membrane, which uses a solid polymer proton conductive membrane, 47 denotes a fuel electrode, 48 denotes an air electrode, and 49 and 50 denote gas-permeable carbon sheet. Active carbon, etc. that supports Pt—Ru is used for the fuel electrode 47, and active carbon, etc. that supports Pt is used for the air electrode 48. The carbon sheet 49, 50 are sheets having gas permeability and electric conductivity. A methanol/water fuel 52 is accommodated in the fuel tank 40, supplying the fuel to the fuel electrode 47 side with capillary tube 54 such as cotton string. Air is supplied to the air electrode 48 side through the air supply hole 56, and produced water is discharged through capillary tube 55.

Since in case of the fuel cell 32 of FIGS. 3 and 4, the user is the general consumer, a risk of using a methanol fuel is larger than that of a stationary type fuel cell 2. The main purposes of coloring or scenting the fuel is to warn when the user handles the fuel cartridge or when the fuel begins to leak. Then, as in the case of the example of FIGS. 3 and 4, the fuel is colored with carbon fine powder or dye or scented with formic acid, methyl formate, etc. A material, particle size, the concentration, etc. of the coloring agent or scenting agent may be determined as in the example of FIGS. 1 and 2. Further, if carbon fine powder is used as a coloring agent, the carbon fine powder will remain inside the cartridge and the fuel tank 40. In the case where a dye is used, active carbon sheet, active carbon granule that is formed into an appropriate shape, or the like is accommodated in the fuel tank 40 as a filter, and the dye is removed in the fuel tank 40. Alternatively, a container of the fuel cartridge is made transparent, a fuel added with a dye is made to be adsorbed by capillary tube or porous material and accommodated in the cartridge, so that the capillary tube or porous material is dyed with the dye. Then, because the capillary tube or porous material is dyed, the fuel in the cartridge apparently looks colored. However, since most part of the dye is adsorbed in the capillary tube, etc., the fuel coming out of the cartridge hardly contains the dye; therefore, it is unnecessary to remove the dye on the fuel cell side. In the case where a scenting agent is used, most part of the scenting agent is decomposed on the fuel electrode 47, a part thereof is discharged into the waste liquid tank 42 by crossing over the proton conductive membrane 46.

### TEST EXAMPLE

Nafion 117 (Nafion being a registered trademark of E. I. du Pont de Nemours & Co.) was used as a proton conductive membrane. Active carbon that supports Pt—Ru was used as a fuel electrode, and PTFE and Nafion were used as a binder. Active carbon that supports Pt was used as an air electrode, and the PTFE and Nafion was used as a binder similarly. The proton conductive membrane was disposed between the air electrode and the fuel electrode, and hot-pressed with carbon sheet being put on upper and lower sides of this to manufacture an MEA. A graphite plate was used as a separator plate, on which an air supply passage and a fuel supply passage are formed with the following dimensions: the groove depth and the groove width of the air electrode side were both set to 3 mm; and the groove depth and the groove width of the fuel electrode side were set to 1 mm and 3 mm, respectively. The unit cell thus manufactured was operated at a cell temperature of 80° C. 3 wt % methanol aqueous solution to which a coloring agent or scenting agent was added was used as the fuel and was supplied to the cell at 4 ml/min. The amount of air supply was set to 1 l/min. The cell was put into a continuous 20-hour operation with an output current of 200 mA/cm², and a maximum output density was measured before and after it.

Acetylene black that had a secondary particle size of about 1 μm and was dispersed in the fuel by 0.01-10 wt % was used as a coloring agent. Then the cell characteristics and the degree of coloring were evaluated. The result is shown in Table 1, showing that the fuel can be colored with addition of 0.03 wt % or more and that even with addition of about 10 wt %, the cell characteristics were caused to vary only a little. Based on this result, if carbon powder is added to the fuel by about 0.03-10 wt %, it does warn the user of its presence. Preferably, carbon powder is added by 0.03-3 wt %, more preferably 0.1-1 wt %.

Table 2 shows results in case of using scenting agents that are formic acid, methyl formate, and a mixture of methyl formate and formic acid to a weight ratio of 1:1, respectively. The results show that effects of these scenting agents on the cell characteristics were not observable and each can be used as a scenting agent.

Table 3 shows effects of a dye of Acid Blue 9 on the cell characteristics in case of adding it by 100 wtppm. Note that practically, addition of about 5 wtppm is enough to color the fuel, and consequently addition of 100 wtppm corresponds to an acceleration test with 20 times the practical concentration. If the kind of a dye is changed, the fuel can be colored sufficiently with a lower concentration of the dye. When an active carbon filter was provided, no effect of the dye on the cell characteristics was observable. Without provision of the filter, the output decreased by a little less than 20% for the continuous 20-hour operation. A coloring agent and a scenting agent may be added together, and two kinds of scenting agents may be used together. It is desirable that a scenting agent is added by 1 wt % or more, but addition exceeding 10 wt % causes a sufficiently strong smell. Preferably, it is added by 3-10 wt %.

TABLE 1
Effect of acetylene black

| | Sample number | | | | | |
|---|---|---|---|---|---|---|
| | C1 | C2 | E1 | E2 | E3 | E4 |
| Amount of addition | 0 | 0.01 | 0.03 | 0.1 | 1 | 10 |
| of acetylene black (wt %) | | | | | | |
| Final value of maximum | 115 | 118 | 115 | 114 | 117 | 116 |
| output density (mW/cm²) | | | | | | |
| Cell resistance (Ω) | 4.1 | 3.9 | 4.1 | 4.0 | 4.1 | 3.8 |
| Degree of coloring | Transparent | Transparent | Colored | Colored | Black | Same |
| | | | (light) | (dark) | like ink | as left |

* Fuel is a 3wt % methanol aqueous solution.
* Sample number with C denotes a comparative example, and sample number with E denotes an example of the patent application.
* Coloring is observed with the eye on the fuel in a sample tube with white paper on its back.
* Variation in a maximum output density in a continuous 20-hour operation (difference between the final and initial values) is ±3 mW/cm² or less for each sample.

TABLE 2
Effect of scenting agent

| | | | | | | | | | | Methyl formate + | | | |
|---|---|---|---|---|---|---|---|---|---|---|---|---|---|
| Scenting agent | Blank | Formic acid | | | | Methyl formate | | | | Formic acid(1:1) | | | |
| Amount of | 0 | 1 | 3 | 6 | 10 | 1 | 3 | 6 | 10 | 1 | 3 | 6 | 10 |
| addition (wt %) | | | | | | | | | | | | | |
| Final value of | 115 | 117 | 114 | 120 | 118 | 121 | 115 | 112 | 114 | 113 | 117 | 117 | 118 |
| maximum output | | | | | | | | | | | | | |
| density (mW/cm²) | | | | | | | | | | | | | |
| Cell resistance (Ω) | 4.1 | 4.0 | 4.1 | 4.1 | 3.8 | 3.9 | 4.0 | 4.1 | 3.9 | 3.9 | 4.0 | 3.7 | 3.8 |
| Fuel smell | 0 | 2 | 7 | 9 | 10 | 1 | 2 | 7 | 10 | 0 | 6 | 10 | 10 |

| | | | | |
|---|---|---|---|---|
| Bad smell at | Nothing | Nothing for all | Nothing for all | Nothing for all |
| electric power | | | | |
| generation test | | | | |

* The fuel is a 3wt % methanol aqueous solution.
* A foul smell when generating electric power was evaluated by the number of subjects who felt unpleasantness among 10 subjects who sensed a smell in proximity of 50 cm to the unit cell under test.
* Fuel smell was evaluated by the number of subjects who felt unpleasantness among 10 subjects who sensed a smell of the fuel supported in a beaker.
* Variation of a maximum output density in a continuous 20-hour operation (difference of final and initial values) is ±3 mW/cm² or less for each sample.

TABLE 3
Effect of dye and active carbon filter

| | | Sample | |
|---|---|---|---|
| | | With active | Without |
| | | carbon filter | filter |
| Maximum output | Before operation | 115 | 117 |
| density (mW/cm²) | After operation | 113 | 98 |
| Cell resistance (Ω) | (initial value) | 4.1 | 4.0 |

Note
Fuel after permeating through the filter was colorless.
* 100-wtppm Acid Blue 9 was added as a dye to a 3 wt % methanol aqueous solution of the fuel.
* The maximum output density was measured before and after the continuous 20-hour operation.

(Fuel of Fuel Cell)

A fuel such as methanol/water, to which a coloring agent or scenting agent is added can be used for a liquid fuel type fuel cell after being filled in a cartridge or contained in an appropriate vessel. In this case, what is necessary is just to be able to prevent the fuel from being misused by the time it is used for the fuel cell. Moreover, kinds of preferable coloring agent and scenting agent, concentrations, and mean particle sizes, etc. thereof in this case are the same as those in the example. Furthermore, an antiseptic may be added in the fuel in the cartridge or the like.

(Filter Cartridge)

The filter cartridge 20 of FIG. 2 is not used only to remove a dye, etc. in the fuel, but also can be used to remove various additives into the fuel or remove various impurities in the waste fuel, etc. Preferably, it is attached detachably to piping of the fuel or waste fuel, and a fuel side entrance and a waste fuel side exist of the cell stack. Alternatively, it is disposed in a taking-in and -out free manner in a fuel tank, a high concentration methanol tank, or the waste fuel tank.

### THIRD EXAMPLE

The following test example was conducted to confirm possibility of putrefaction of the fuel, etc. and an effect of an antiseptic in the direct methanol fuel cell.

### EXAMPLE OF TEST

Para-oxybenzoic acid, para-dihydroxybenzene, and phenol each of 0.5 wt % were added to a 3 wt % methanol aqueous solution fuel to prepare samples B, C, and D (examples), respectively, whereas Sample A to which no antiseptic was added was prepared as a comparative example. Each of these samples is filled in a container, the end of absorbent cotton is dipped in the container so that the whole absorbent cotton is supplied with the sample by means of the capillary phenomenon. The samples are left unused for one weak in air at room temperature (about 15-25° C.) and a state of the absorbent cotton after one week was observed. Table 4 shows these results. In Sample A with no addition of an antiseptic, generation of bacteria and mold was observed and its putrefactive smell was close to an acid smell similar to a formic acid smell.

TABLE 4
Putrefaction prevention effect of fuel by addition of antiseptic

| | Sample | | | |
|---|---|---|---|---|
| | A | B | C | D |
| Anti- | No addition | Para- | Para- | Phenol |
| septic | | oxybenzoic | dihydroxy- | |
| | | acid | benzene | |
| State | Giving | No change | No change | No change |
| | putrefactive | | | |
| | smell | | | |
| | Colored into | | | |
| | brownish | | | |

Next, effectiveness of the fuels B to D to each of which the antiseptic was added were evaluated in terms of cell characteristics. Nafion 117 (Nafion being a registered trademark of E. I. du Pont de Nemours & Co.) was used for an electrolyte membrane in the unit cell used in the test. As the fuel electrode and the air electrode, one that was manufactured by applying a mixture of commercial Pt—Ru/C catalyst, Pt/C catalyst (a product from the Tanaka Kikinzoku Kogyo K.K.), Nafion solution (a product from SIGMA-ALDRICH Corp.) and PTFE solution for giving water repellence (a product form E. I. du Pont de Nemours) on carbon paper. They were joined by the hot pressing method at 140° C. under 980 N/cm² to obtain an MEA (Membrane Electrode Assembly). This MEA was supported on its both sides by separator plates made from graphite to prepare a unit cell with an effective electrode area of 36 cm². This unit cell was heated to 90° C. and operated under operating conditions of a fuel flow speed of 8 ml/min and an air flow speed of 5 l/min using four kinds of fuels A to D in Table 4 for two weeks, and after that initial values of the current/voltage characteristics were measured. Next, each unit cell was connected to the fuel tank and the waste fuel tank and left unused at room temperature (15-25° C.) for one month under a condition where air was able to go into and out from the MEA through an air supplying groove of the separator by natural ventilation. The current/voltage characteristics were measured again under the same conditions.

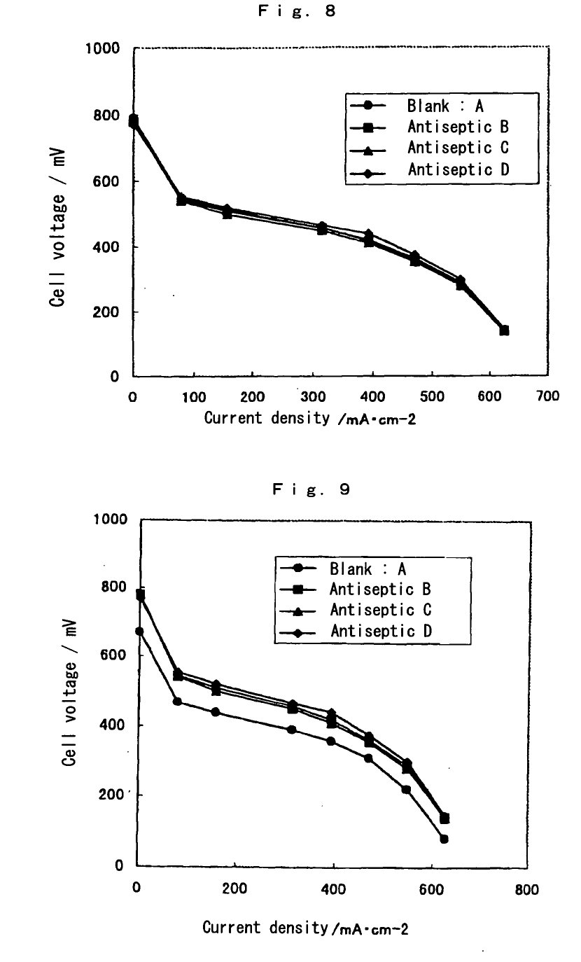

FIG. 8 shows initial current/voltage characteristics. Samples B to D with addition of the antiseptic exhibited the same characteristics as those of Sample A without addition of the antiseptic, and no effect of the antiseptic was observed in the continuous two-week operation. This indicated that poisoning of the electrode by the antiseptic, etc. did not occur. Moreover, a fact that Sample A without addition of the antiseptic exhibited the comparable performance as those of Samples B to D with addition of the antiseptic in the continuous two-week operation indicated that it was hard for microorganisms to breed under the operating condition of 90° C.

FIG. 9 shows characteristics after the above-mentioned four kinds of unit cells were left unused in air for one month. Sample A with no addition of the antiseptic fell in the cell characteristics by about 15%, and it gave out a foul smell when it's used to generate electric power. On the other hand, Samples B-D with addition of the antiseptic did not fall in the cell characteristics even after being left unused for one month, which showed that neither the poisoning of the electrode nor the breeding of microorganisms occurred by virtue of the antiseptic.

A 3 wt % methanol/water fuel to which active carbon with silver chloride deposited on it (silver chloride content: 2 wt %), as an example of inorganic antiseptics, being added by 0.5 wt %, was prepared. The concentration of the antiseptic in the fuel was 100 wtppm. Using this fuel and the same unit cell as in the above, the initial characteristics of the unit cell and characteristics after being left unused in air for one month in the same away as in the above were measured. The one-month standing neither caused it to fall in the cell characteristics nor caused it to be generated putrefactive smell.

By the above-mentioned test example, we were able to confirm that in the direct methanol fuel cell, putrefaction arose in the fuel, the waste fuel, or in the surrounding of the MEA, etc. by being left unused at room temperature. Considering a fact that generation of putrefaction was not observed during an operation at 90° C., the problem of putrefaction should be serious in a small sized direct methanol fuel cell for portable electronic devices whose operation temperature is in the neighborhood of room temperature. Then, one embodiment about such a fuel cell was examined. FIGS. 5 and 6 show a direct methanol fuel cell 102 of the embodiment, wherein the numeral 104 denotes a cell stack in which MEA's 106 are connected serially being sandwiched with separators 107-109. The numeral 110 denotes an air supplying hole drilled in the separators 107, 109, supplying air to the air electrode. For example, a fuel tank 112 and a waste fuel tank 114 are arranged being overlaid under the cell stack 104 so that a methanol/water fuel (concentration: about 1-10 wt %) is supplied through a valve 115 and the waste fuel is discarded through a valve 116.

FIG. 6 shows a structure of the unit cell, wherein the numeral 120 denotes a proton conductive membrane such as Nafion 117, 121 denotes a fuel electrode such as of Pt—Ru/C, and 122 denotes an air electrode such as of Pt/C. Compositions and the structures themselves of the fuel electrode 121 and the air electrode 122 are well known. The numerals 123, 124 denote carbon sheet having gas permeability arranged both between the fuel electrode 121 and the separator 107, and the air electrode 122 and the separator 107. The numeral 125 denotes capillary tube for supplying a methanol/water fuel 128 to the carbon sheet 123 from the fuel tank 112 using, for example, cotton string, etc. Capillary tube 126 discharges produced water, etc. from the carbon sheet 124 to the waste fuel tank 114.

In the direct methanol fuel cell 102 of FIGS. 5 and 6, since the operation temperature is near room temperature up to about 40° C., there is the possibility that putrefaction may advance even during an operation of the fuel cell. Moreover, at the time of being left unused, it is difficult to completely seal the air supply hole 110 and microorganisms are likely to invade inside through the valves 115, 116. In consideration of this, an antiseptic such as para-oxybenzoic acid, para-dihydroxybenzene, and phenol is added to the methanol/water fuel of the fuel tank 112 to the extent of, for example, about 0.01-1 wt %. The antiseptic is supplied to all portions of the MEA 106, the waste fuel tank 114, etc. along with the fuel and produced water, and prevents putrefaction. The antiseptic does not react with the electrodes 121,122. It permeates through the MEA 106 through a crossover, a gap in the periphery of the MEA 106, etc. and is discharged to the waste fuel tank 114 side and discarded through the valve 116 along with the produced water. Incidentally, antiseptics of para-oxybenzoic acid, para-dihydroxybenzene, phenol, etc. are safe whatever touches with the hand at the time of discarding.

An adding position of the antiseptic is not limited to the inside of the fuel. For example, active carbon that supports an inorganic antiseptic insoluble to water may be added in the fuel tank 112 or the waste fuel tank 114 in the form of powder, or may be added after it is granulated or made into the form of sheet. Alternatively, the organic aromaticity antiseptic may be added in the fuel tank 112 or the waste fuel tank 114 after being given a sustained release property by mixing it with an appropriate amount of an extending agent. Moreover, an antiseptic may be added to the surface of the capillary tube 125,126, etc. of the carbon sheet 123,124, the capillary tube 125,126, etc.

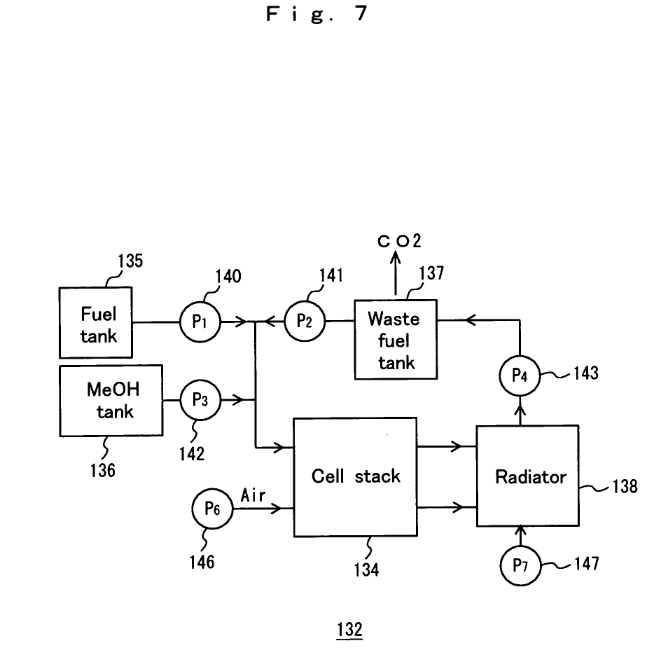

FIG. 7 shows a direct methanol fuel cell 132 equipped with the liquid sending pumps 140-143. The numeral 134 denotes a cell stack with an operation temperature of about 60-80° C., 135 denotes a fuel tank, and 136 denotes the methanol tank for accommodating methanol of as high a concentration as 60 wt % or the like. The numeral 137 denotes a waste fuel tank that accommodates the waste fuel and allows CO₂ generated by the fuel electrode to be introduced into it. Coming along with this, in case of using an organic aromaticity antiseptic, a part of it is lost from the waste fuel tank 137, etc. by evaporation. The numeral 138 denotes a radiator that liquefies steam, cools it with air from an air pump 147, and sends the waste liquid to the waste fuel tank 137 through the liquid sending pump 143, making it circulate. The numeral 140 denotes a pump for supplying the fuel from the fuel tank 135, 141 denotes a pump for circulating the waste fuel from the waste fuel tank 137, and 142 denotes a pump for adding methanol from the methanol tank 136. The numeral 146 denotes an air pump for supplying air to the cell stack 134.

Since the cell stack 134 is maintained at high temperature during the operation in the direct methanol fuel cell 132 of FIG. 7, the possibility of putrefaction in this portion is low. However, even it is operating, the fuel is likely to putrefy in the waste fuel tank 137 and the radiator 138. In consideration of this, for example, the above-mentioned organic aromaticity antiseptic, etc. is added to the fuel in the fuel tank 135 to prevent putrefaction. Since the added antiseptic will not be lost except evaporation from the waste fuel tank 137, etc., for example, an about 0.05-1 wt % antiseptic is added to the fuel to be added to the fuel tank 135 at the time of start up of the operation. After the operation started, the concentration of the antiseptic to be added to the fuel tank 135 is set to, for example, about 0.01 wt %, so that the antiseptic lost by evaporation from the waste fuel tank 137, etc. is replenished. Note that in the direct methanol fuel cell of FIGS. 5 and 6, if the antiseptic supported by active carbon is added into the fuel, the active carbon will accumulate in the fuel tank 112. On the other hand, in the direct methanol fuel cell 132 of FIG. 7, even if the antiseptic supported by active carbon is mixed with the fuel, it can be used cyclically along with the waste fuel.

What is claimed is:

1. A liquid fuel type fuel cell that has an air electrode and a fuel electrode provided on both sides of a proton conductive membrane to form an MEA, and generates electric power by supplying water liquid fuel to the fuel electrode of the MEA and supplying air to the air electrode,
wherein the fuel is colored or scented, or an antiseptic is added to the fuel.

2. The liquid fuel type fuel cell of claim 1, wherein a coloring agent or a scenting agent is added to the fuel.

3. The liquid fuel type fuel cell of claim 2, wherein the fuel is colored black by dispersing carbon fine powder into the fuel.

4. The liquid fuel type fuel cell of claim 2, wherein the fuel is colored by adding a pigment into the fuel.

5. The liquid fuel type fuel cell of claim 4, wherein the pigment is a dye and a filter for removing the dye is provided in the upstream of the MEA.

6. The liquid fuel type fuel cell of claim 5, wherein the filter is one that adsorbs the dye with active carbon.

7. The liquid fuel type fuel cell of claim 5, wherein the filter is a filter cartridge being detachably attached to a fuel supplying system.

8. The liquid fuel type fuel cell of claim 2, wherein a carboxylic acid with a carbon number of 1-4, an ester of a carboxylic acid with a carbon number of 1-4 and an alcohol with a carbon number of 1-4, or an ether of two alkyl groups each with a carbon number of 1-4 is added into the fuel so that the fuel is scented.

9. A liquid fuel type fuel cell, wherein an antiseptic is added into a fuel.

10. The liquid fuel type fuel cell of claim 9, wherein the antiseptic is added into the fuel.

11. The liquid fuel type fuel cell of claim 9, wherein the antiseptic is either an organic aromaticity antiseptic including oxygen atoms or an inorganic antiseptic that is supported by a support and is insoluble to water.

12. A liquid fuel type fuel cell that has an air electrode and a fuel electrode provided on both sides of a proton conductive membrane to form an MEA, and generates electric power by supplying water liquid fuel to the fuel electrode of the MEA and supplying air to the air electrode,
wherein an antiseptic is added to the cell.

13. A fuel for a liquid fuel type fuel cell that uses a proton conductive membrane, wherein the fuel is colored or scented, or an antiseptic is added to the fuel.

14. The fuel for the liquid fuel type fuel cell of claim 13, wherein the fuel is colored black by carbon fine powder.

15. The fuel for the liquid fuel type fuel cell of claim 13, wherein the fuel is colored with a dye.

16. The fuel for the liquid fuel type fuel cell of claim 13, wherein the fuel is scented with carboxylic acid with a carbon number of 1-4, or ether of carboxylic acid with a carbon number of 1-4 and alcohol with a carbon number 1-4, or ether of two alkyl groups each with a carbon number of 1-4.

17. A liquid fuel type fuel cell that has an air electrode and a fuel electrode provided on both sides of a proton conductive membrane to form an MEA, and generates electric power by supplying water liquid fuel to the fuel electrode of the MEA and supplying air to the air electrode, comprising
a filter for removing additives or impurities in the fuel or in waste fuel.

18. The liquid fuel type fuel cell of claim 17, wherein the filter is a detachable filter cartridge.
